(19) United States
(12) Patent Application Publication
(10) Pub. No.: US 2010/0145677 A1
(43) Pub. Date: Jun. 10, 2010

(54) System and Method for Making a User Dependent Language Model

(75) Inventor: Chang-Qing Shu, Orlando, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(73) Assignee: ADACEL SYSTEMS, INC., Orlando, FL (US)

(21) Appl. No.: 12/396,933

(22) Filed: Mar. 3, 2009

Related U.S. Application Data
(60) Provisional application No. 61/119,776, filed on Dec. 4, 2008.

(51) Int. Cl. G06F 17/27; G06F 17/30

(52) U.S. Cl. 704/9; 707/E17.009

(57) ABSTRACT

A language model for a speech recognition engine is made based on user-viewed data files. The data files are reviewed and texts are extracted therefrom. The language model is generated based on the extracted texts. Transcriptions of previous user statements are not required. Different weighting factors can be applied to elements of the extracted texts based on the nature of the data files. The weighting factors are then considered during generation of the language model. A user dependent and application independent language model can be created prior to initial use of the speech recognition engine.

### CROSS-REFERENCE TO RELATED APPLICATION

This application claims the benefit of U.S. Provisional Application Ser. No. 61/119,776, filed on Dec. 4, 2008, the contents of which are hereby incorporated by reference in their entirety.

### FIELD OF THE INVENTION

The present invention relates to speech recognition systems and methods, and more particularly, to the formation of language models for speech recognition engines.

### BACKGROUND OF THE INVENTION

Referring to FIG. 6, in a typical speech recognition engine 1000, a signal 1002 corresponding to speech 1004 is fed into a front end module 1006. The front end 1006 module extracts feature data 1008 from the signal 1002. The feature data 1008 is input to a decoder 1010, which the decoder 1010 outputs as recognized speech 1012. An application 1014 could, for example, take the recognized speech 1012 as an input to display to a user, or as a command that results in the performance of predetermined actions.

To facilitate speech recognition, an acoustic model 1018 and a language model 1020 also supply inputs to the decoder 1010. The acoustic model 1018 utilizes the decoder 1010 to segment the input speech into a set of speech elements and identify to what speech elements the received feature data 1008 most closely correlates. For greater speech recognition accuracy, the acoustic model 1018 can be “tuned” by having a user of the speech recognition engine 1000 read a corpus of known texts.

The language model 1020 consists of the certain context dependent words, groups of words and other language elements based on assumptions about what a user is likely to say. The language model 1020 cooperates with the acoustic model 1018 to assist the decoder 1010 in further constraining the possible recognized speech 1012.

Some efforts have been made to tune a language model using transcribed speeches by a user, for instance, in parallel with creating a user-specific acoustic model. Given a sufficiently representative sample of transcribed speeches, this would theoretically yield a language model that is likely to increase recognition accuracy for the corresponding user without being tied to a particular application. However, to be effective, this approach requires a large volume of transcribed text from the user; something the average computer user is unlikely to have available, or at least something that would require a large amount of time and effort to develop.

Some systems further tune the language model based on corrections made to speech recognition errors, but this approach requires an appreciable amount of time and patience after the initial use of a speech recognition engine before accuracy rates become acceptable. In practice, few users, and particularly, few personal computer users, are willing to make the necessary time investment and quickly give up on the speech recognition engine.

### SUMMARY OF THE INVENTION

It is an object of the present invention to make a language model for a speech recognition engine based on user-viewed data files. The data files are reviewed and texts are extracted therefrom. The language model is generated based on the extracted texts. Transcriptions of previous user statements are not required. Different weighting factors can be applied to elements of the extracted texts based on the nature of the data files. The weighting factors are then considered during generation of the language model. A user dependent and application independent language model can be created prior to initial use of the speech recognition engine.

According to an embodiment of the present invention, a system for making a language model for a speech recognition engine includes an extraction module configured to review a plurality of user-viewed data files and extract texts therefrom, a segmentation module configured to generate separate text element lists from the extracted texts, a merger module configured to generate a merged text element list from the separate text element lists, and a sorting module configured to generate a sorted text element list based on the merged text element list.

According to a method aspect of the present invention, a method of making a language model for a speech recognition engine includes reviewing a plurality of user-viewed data files, extracting texts from the data files, associating weighting factors with the extracted texts, and generating a sorted text element list based on the extracted texts and the weighting factors.

Thus, the present invention allows for the formation of a user dependent language model without the need for any transcriptions of user statements and prior to operation of a speech recognition engine. These and other objects, aspects and advantages of the present invention will be better appreciated in view of the following detailed description of a preferred embodiment and accompanying drawings.

### BRIEF DESCRIPTION OF THE DRAWINGS

FIG. 1 is a schematic overview of a computer-based system for making a user dependent language model for a speech recognition engine; according to an embodiment of the present invention;

FIGS. 2-5 are a flow diagram of a method executable by the system of FIG. 1; and

FIG. 6 is a schematic overview of a typical speech recognition engine.

### DETAILED DESCRIPTION OF A PREFERRED EMBODIMENT

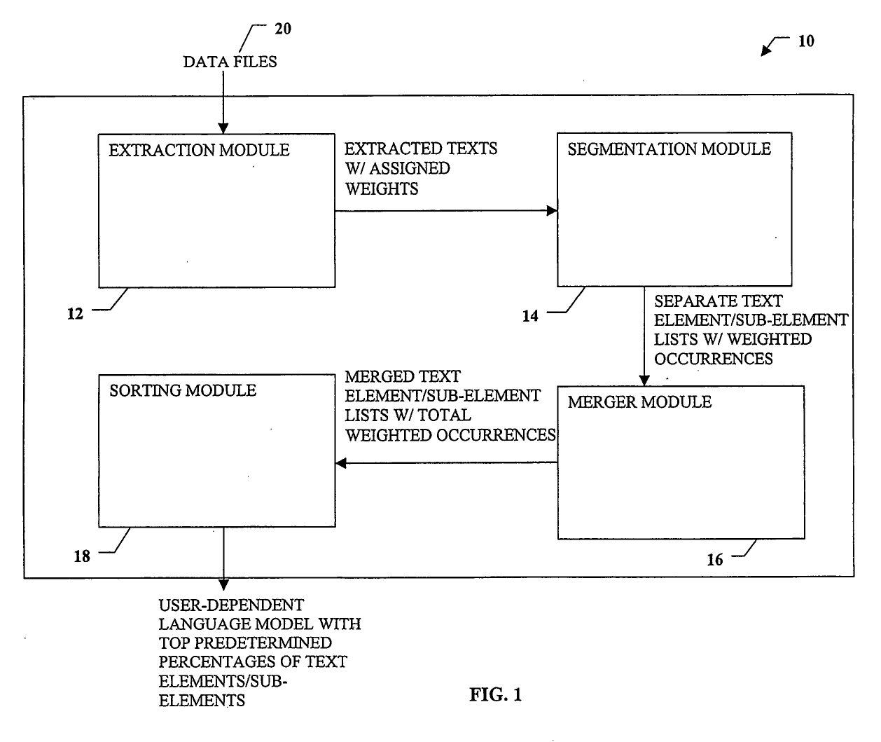

Referring to FIG. 1, a system 10 for making a user dependent language model for a speech recognition engine includes an extraction module 12, a segmentation module 14, a merger module 16, and a sorting module 18. It will be appreciated that speech recognition engines are inherently machine processor-based. Accordingly, the systems and methods herein signifies that the systems or methods are realized by at least one processor executing machine-readable code and that outputs of the system or method are stored, at least temporarily, in some form of machine-readable memory. However, the present invention is not necessarily limited to particular processor types, numbers or designs, to particular code formats or languages, or to particular hardware or software memory media.

The extraction module 12 is configured to review a plurality of data files 20 to find data files associated with a user. For instance, the extraction module 12 can review data files located on hard drive in a computer associated with the user or accessible to the user over a local area network for user-viewed text. The extraction module 12 can be configured to specifically review or exclude certain types of data files. For example, spreadsheets could be specifically excluded.

The extraction module 12 is further configured to extract user-viewed texts from the data files and, preferably, convert each text into a normalized format for further use by the system 10. Text that is not user-viewed, such as embedded commands in web pages, is preferably not extracted. Character recognition routines can be employed to extract text from image documents. It will be appreciated that, depending on file format, the extracted text may be substantially identical to the original data file.

The extraction module 12 is also configured to assign weighting factors to the extracted texts. Preferably, the weighting factors are assigned based upon the degree to which the extracted texts can be considered representative of the language usage of the user. For example, text actually written by the user can be considered more likely to reflect language usage of the user than text only read by the user. Additionally, text that the user has closely read can be considered more likely to reflect language usage of the user than text only viewed by the user.

Various criteria can be established for ascertaining whether data files are user-viewed, as well as determining how representative extracted texts are of the language usage of the user. For example, the extraction module 12 can treat as user-viewed data files only those data files accessed by the user. How representative the extracted texts are can be further determined based on whether and/or to what extent, the corresponding data files were generated by the user, modified by the user, or only opened by the user.

Also, the type of the data file can be used as criteria for determining the representative nature of the extracted texts. For instance, emails, text messages, chat files and other data files constituting textual communications sent to or from the user, referred to generally as “correspondence data files” can be considered more likely to represent the language of the user than other data files. Amongst correspondence data files, those correspondence data files that are user-generated, or at least those portions thereof that are user-generated, can be considered more representative than correspondence data files received from others. Additionally, correspondence data files to which the user has generated a reply can be considered more representative than correspondence data files to which the user has not replied.

An exemplary hierarchy of weighting factors (Bⱼ), where j is the data file type, includes:

B₁—User-generated texts from correspondence data files;

B₂—User-generated texts from other data files;

B₃—Non-user-generated texts from correspondence data files received and replied to;

B₄—Non-user-generated texts from correspondence data files received, opened and not replied to; and

B₅—Non-user-generated texts from other data files.

In the above example, B₁≧B₂≧B₃≧B₄≧B₅. Non-exclusive examples of B₁ texts can include emails drafted by the user, text messages drafted by the user, and chat comments in a chat file that are drafted by the user. Non-exclusive examples of B₂ data files can include word processor documents files by the user and note files written by the user. Non-exclusive examples of B₃ data files can include emails and text messages replied to by the user, and chat comments in a chat file not drafted by the user. Non-exclusive examples of B₄ data files can include emails and text messages received but not replied by the user, and chat comments in a chat file in which the user was not an active participant. Non-exclusive examples of B₅ data files can include web pages, stored magazine articles, and instruction manual documents.

Notably, these data file types are likely to be present in significant numbers on a computer system regularly accessed by the user, and do not require the creation and input of transcriptions of user statements.

The extraction module 12 outputs the texts extracted from the data files, and the associated weighting factors, to the segmentation module 14. The segmentation module 14 is configured to break each extracted text into separate lists of text elements and sub-elements. Advantageously, these can include separate sentence, phrase and word lists. It will be appreciated that the present invention is not necessarily limited to these types or quantities of text elements and sub-elements. Also, element and sub-element are relative to each other; a sub-element being a constituent of an element, and does not necessarily restrict the identity of the element. For example, sentences could be elements with words as sub-elements. Alternately, words could be elements, with syllables or phonemes as sub-elements. Additionally, element and sub-elements can be context dependent or context independent.

The extraction module 12 can also identify topic identifications (IDs) to which the extracted texts relate. For example, the extraction module 12 can include a list of topic IDs and associated key words, phrases or the like that indicate a given text should associated with a particular topic ID. Then, when the speech recognition engine is being used to recognize speech from one of the topic IDs, the language model can preferentially use text elements/sub-elements from texts relating to that topic ID.

The segmentation module 14 is also configured to determine weighted occurrences of the elements and sub-elements in the separate lists. An exemplary scheme for determining word, phrase and sentence weighted occurrences C_{wij}, Cₚᵢⱼ, Cₛᵢⱼ, where i is an index of each element, the j is the index of the extracted text, includes:

Determining the word, phrase and sentence occurrences O_{wij}, Oₚᵢⱼ, Oₛᵢⱼ, for the extracted text; and

Determining C_{wij}, Cₚᵢⱼ, Cₛᵢⱼ by applying the Bⱼ to each occurrence O_{wij}, Oₚᵢⱼ, Oₛᵢⱼ as follows:

C_{wij}=Bⱼ*O_{wij} a.

Cₚᵢⱼ=Bⱼ*Oₚᵢⱼ; and b.

Cₛᵢⱼ=Bⱼ*Oₛᵢⱼ c.

The segmentation module 14 outputs the separate text elements and sub-element lists to the merger module 16. The merger module 16 is configured to merge the separate text element and sub-element lists into merged text element and sub-element lists. The merger module 16 is also configured to determine the total weighted occurrence for each element and sub-element in the merged lists. An exemplary scheme for calculating total weighted occurrence for words, phrases and sentences c_{wi}, cₚᵢ, cₛᵢ includes:

c_{wi}=sum(C_{wij}; j=1, . . . , j=n)

cₚᵢ=sum(Cₚᵢⱼ; j=1, . . . , j=n); and

cₛᵢ=sum(Cₛᵢⱼ; j=1, . . . , j=n).

The merger module 16 outputs the merged text element and sub-element lists and the total weighted occurrences to the sorting module 18. The sorting module 18 sorts the merged text element and sub-element lists based on the total weighted occurrences. The sorted text element and sub-element lists can, themselves, be used to generate the user dependent language model. However, for enhanced speed and accuracy of the speech recognition engine, it is advantageous to further scrutinize the lists to eliminate elements and/or sub-elements that are less likely to be used.

In an exemplary scheme involving word, phrase and sentence lists, the sorting module 18 builds top word, phrase and sentence lists N_{w}, Nₚ, Nₛ by taking an upper predetermined percentage of the words, phrases and sentences in the sorted text element and sub-element lists. Nₛ initially populates a user dependent text element/sub-element set S₂. A temporary phrase set S_{2Temp} is formed by segmenting Nₛ into phrases.

S_{2Temp} phrases are compared Nₚ phrases. If a phrase appears in Nₚ and not in S_{2Temp}, the phrase is added to S₂. If a phrase appears in S_{2Temp} and not in Nₚ, the phrase is disregarded. This helps to identify S_{2Temp} phrases that were erroneous segmentations from the top Nₛ sentences. If a phrase appears in both Nₚ and in S_{2Temp}, the occurrences of the phrase within Nₛ (Oₛₚᵢ) and within Nₚ (Oₚᵢ) are determined. If the comparative occurrence (Oₛₚᵢ/Oₛₚᵢ+Oₚᵢ) is within (≧) a phrase occurrence threshold Thldₚ, the phrase is added to S₂, otherwise the phrase is disregarded. The threshold is set to achieve a desired balance between processing speed and accuracy. A lower threshold results in faster processing and lower accuracy. A higher threshold results in slower processing and higher accuracy.

Nₛ and Nₚ are segmented into a temporary word set S_{3Temp} and a similar comparison is performed with N_{w}. If a word appears in N_{w} and not in S_{3Temp}, the word is added to S₂. If a word appears in S_{3Temp} and not in N_{w}, the word is disregarded. If a word appears in both N_{w} and in S_{3Temp}, the cumulative occurrences of the word within Nₚ and Nₛ (O_{pswi}) and within N_{w} (O_{wi}) are determined. If the comparative occurrence (O_{pswi}/O_{pswi}+O_{wi}) is within (≧) a word occurrence threshold Thld_{w}, the word is added to S₂, otherwise the word is disregarded. Thld_{w} is similar is purpose Thldₚ.

The user dependent text element/sub-element set (S₂) is thereby enhanced by the sorting module 18, which outputs S₂. S₂ can be used to form the language model alone, or advantageously, the sorting module 18 can be further configured to merge S₂ with a user independent text element/sub-element set (S_{I}), such as in an application dependent language model. The relative contribution of each set in the resulting language model (S₁ₜₛ) can be adjusted with confidence factors g_{I} and g₂, where g_{I}+g₂=1, and S₁ₜₛ=S_{I}*g_{I}+S₂*g₂

The value of the confidence factors g_{I} and g₂ will be determined based on the application and the confidence for the personal data processed. For example, g_{I} can be set higher where speech to be recognized is likely to be highly specific to a particular application. Also, various measures of confidence can be used to raise or lower the value of g₂. For example, if a large number of user-created files were available, g₂ could be increased.

The system can further include further modules for performing additional functions in forming the language model. Such additional functions can include assigning phonetic equivalents to the speech elements and sub-elements within the language model and compiling the language into a form useable by a particular speech recognition engine. Additional rules and hierarchies governing employment of the language model can also be added. Given a set of text elements/sub-elements, topic IDs, and the like, there are various ways known in the art to further generate a language model. For example, the text extracted, segmented, merged and sorted by the present invention can be used to further generate a FSG (Finite State Grammar) language model and/or an n-gram language model, although the present invention is not necessarily so limited.

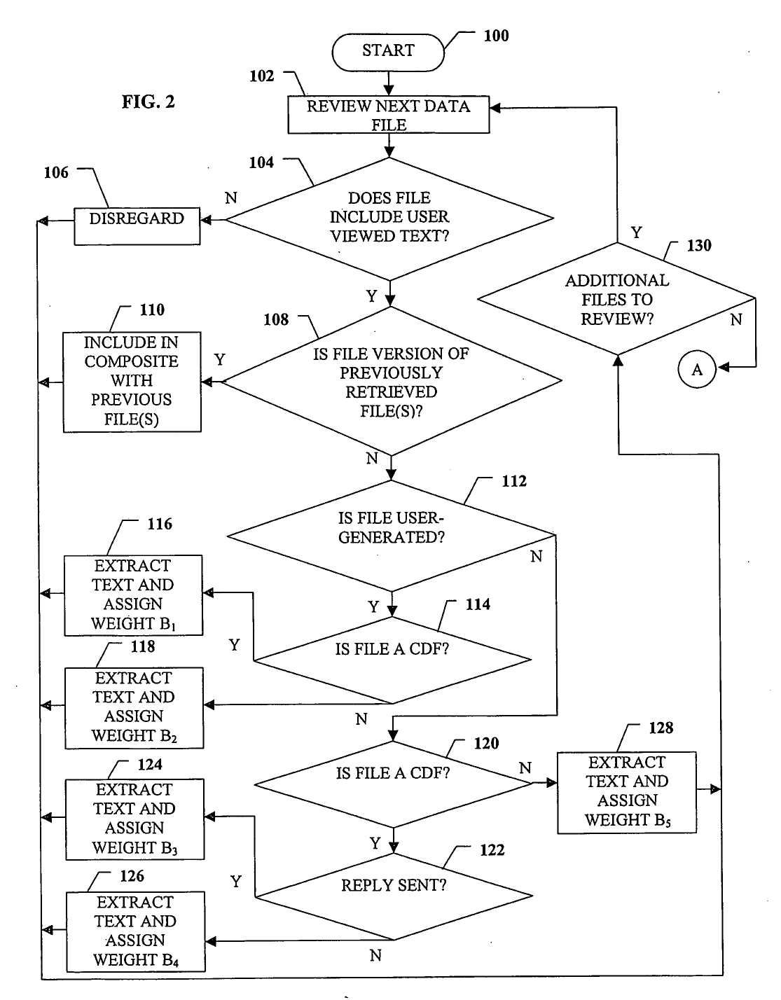

Referring to FIG. 2, according to a method aspect of the present invention, a method for making a user dependent language model for a speech recognition engine starts at block 100. At block 102, a data file is reviewed. If the data file does not include user-viewed text, based on a determination at block 104, the data file is disregarded (block 106).

If the data file includes user-viewed text, it is determined at block 108 whether the data file is a version of a previously-reviewed file or files. If the data file is a version of a previously-reviewed file, the data file is grouped with the previously-reviewed file(s) (block 110). This determination can be made, for example, by a comparison with previously-reviewed files or based on an indication in file properties that the data file is a version of another file. This prevents multiple versions of the same document from inordinately influencing the total weighted occurrences of text elements and sub-elements.

If the data file is not a version of a previously-reviewed file, then at block 112, it is determined if the data file is user generated/created. If the data file is user generated, it is determined at block 114 if the date file is a correspondence data file (CDF). If the data file is a user-generated CDF, the text is extracted and assigned the weighting factor B₁ (block 116). If the data file is user-generated but not a CDF, the text is extracted and assigned the weighting factor B₂ (block 118).

If it was determined that the data file was not user generated at block 112, it is further determined whether the data file is a CDF at block 120. If the data file is a CDF, it is determined whether the CDF was replied to at block 122. If the message was replied to, the text is extracted and assigned the weighting factor B₃ (block 124), otherwise, the text is extracted and assigned the weighting factor B₄ (block 126). If it was determined that the data file was not a CDF at block 120, the text is extracted and assigned the weighting factor B₅ (block 128). It will be appreciated that for certain types of data files, such as chat files, some portions of the data may be user-generated while others are not. In such situations, it is preferable to extract user-generated and non-user-generated portions separately and assign them different weighting factors.

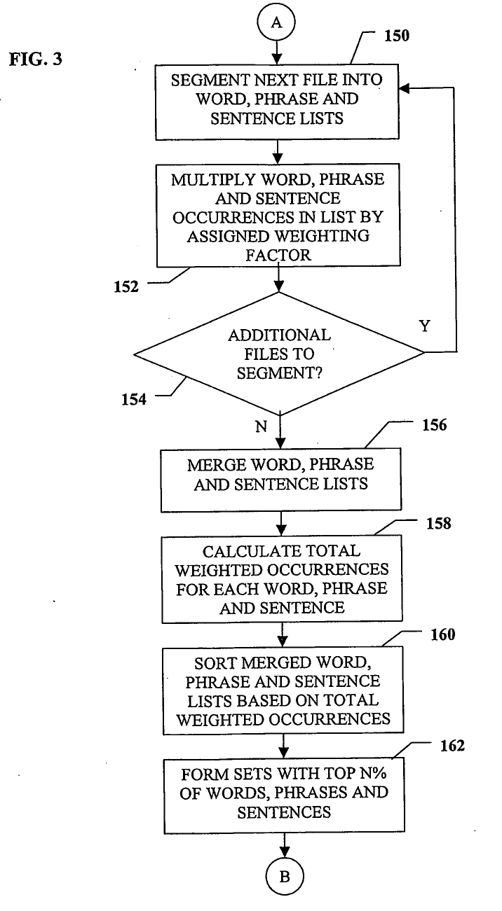

Following the action of blocks 106, 110, 116, 118, 124, 126 or 128, it is determined whether there are more data files to review at block 130. If there are additional data files to review, the method returns to block 102. Otherwise, referring to FIG. 3, at block 150 the first extracted text is segmented into text element and sub-element lists, such as sentence, phrase and word lists. The method is described in terms of these exemplary text elements and sub-elements, although it will be appreciated that the method is not necessarily limited thereto.

At block 152, the occurrence of each word, phrase and sentence is multiplied by the assigned weighting factor. At block 154, it is determined whether there are additional extracted texts to be segmented. If so, the method returns to block 150. Otherwise, at block 156, the separate word, phrase and sentence lists are merged into merged word, phrase and sentence lists. At block 158, total weighted occurrences are determined for each word, phrase and sentence in the merged lists and, at block 160, the merged lists are sorted by weighted occurrence.

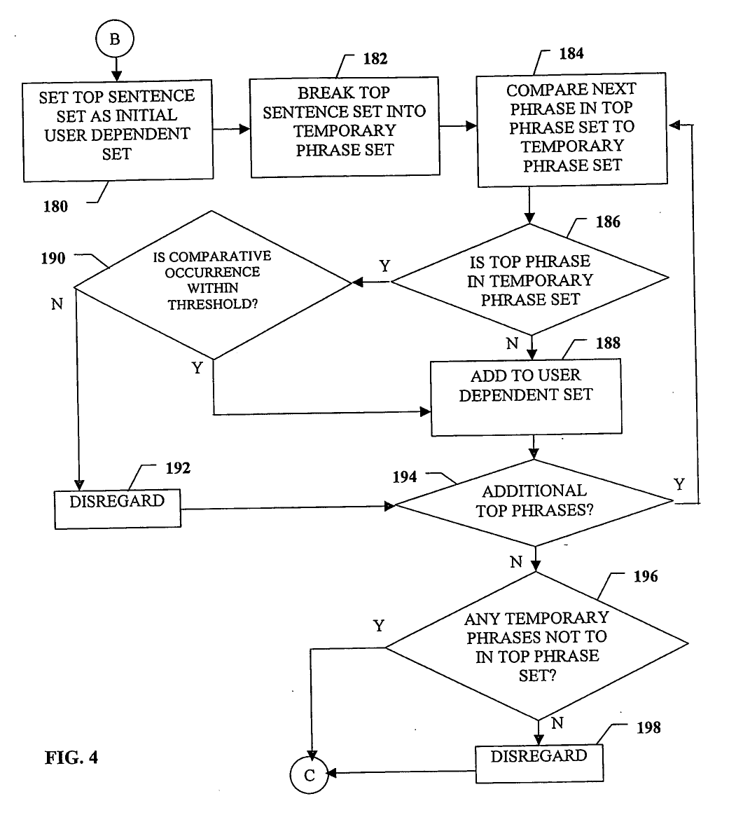

At block 162, top word, phrase and sentence lists are formed by taking a top predetermined percentage of words, phrases and sentences from the sorted lists. Referring to FIG. 4, at block 180 the top predetermined sentences are set as an initial user dependent text element/sub-element set. At block 182, the top sentence set is broken into a temporary phrase set. At block 184, the next phrase in the top phrase set is compared to the temporary phrase set. At block 186, a determination is made whether the top phrase appears in the temporary phrase set. If not, the top phrase is added to the user dependent text element/sub-element set at block 188.

If the top phrase appears in the temporary phrase set, a determination is made at block 190 whether the comparative occurrence of the phrase is within the phrase occurrence threshold. If the top phrase is within the phrase occurrence threshold, the phrase is added to the user dependent text element/sub-element set (block 188); otherwise, the phrase is disregarded (block 192). At block 194, it is determined whether there are additional top phrases for comparison. If there are, the method returns to block 184. If there are no more top phrases, a determination is made at block 196 whether there are any phrases remaining in the temporary phrase list not corresponding to the top phrase set. If there are, any such phrases are disregarded (block 198).

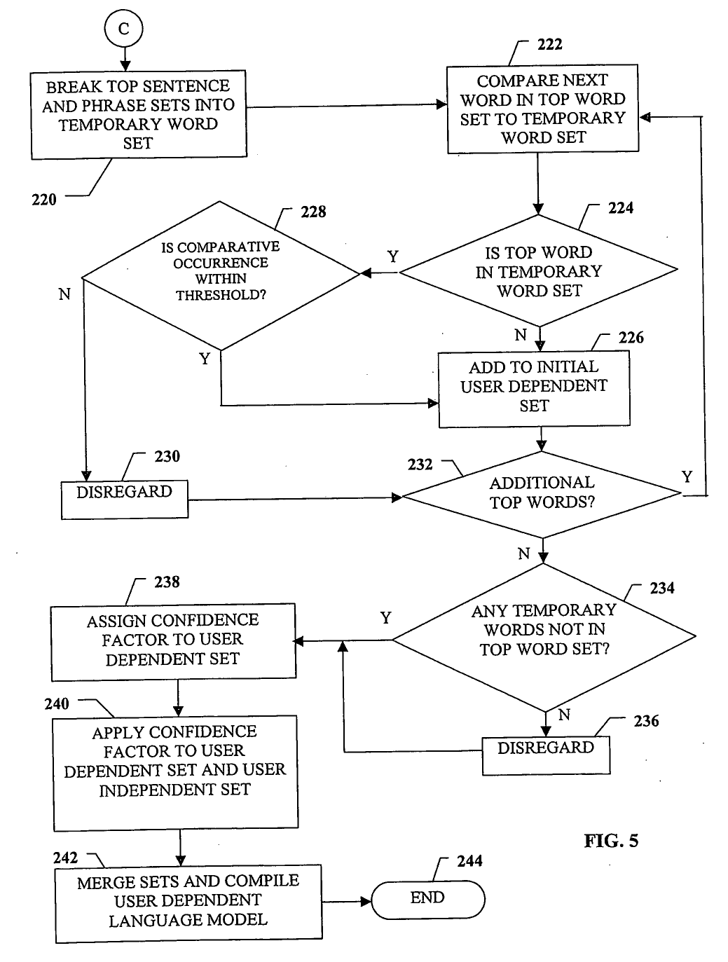

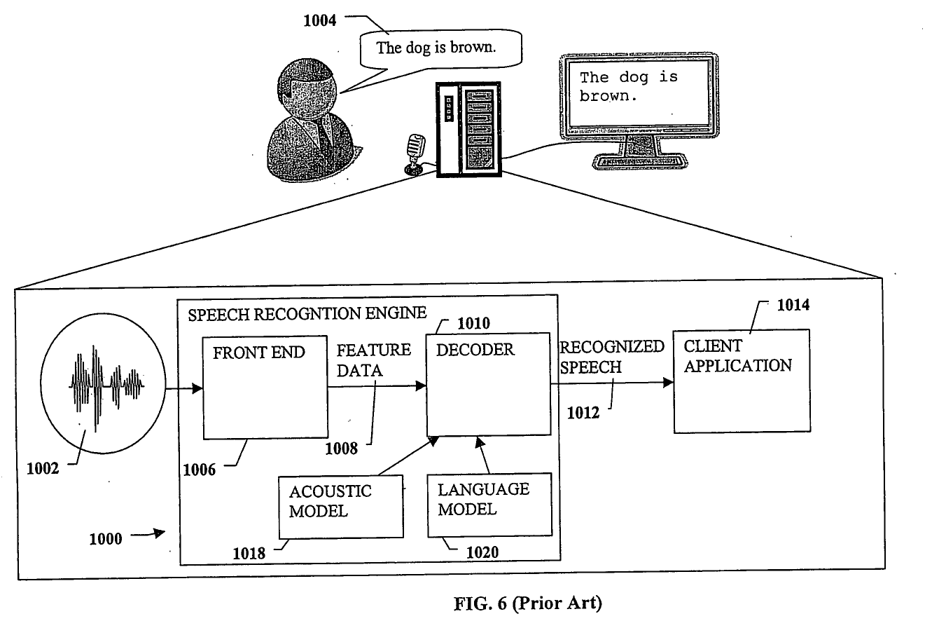

Referring to FIG. 5, at block 220, the top sentences and phrases are segmented into a temporary word set. At blocks 222-236, the top words are compared with the temporary word set in a manner substantially similar to blocks 184-198, with acceptable words being added to the user dependent text element/sub-element set.

At block 238, a confidence factor is assigned to the user dependent text element/sub-element set. At block 240, the confidence factor is applied to the user dependent text element/sub-element set and to a user independent text element/sub-element set, for example, as 1 minus the confidence factor assigned to the user dependent text element/sub-element set. At block 242, the sets are merged based on the confidence factors and the user dependent language model is compiled. At block 244, the method ends. As discussed above in connection with the system 10, there are various additional steps that can be taken to further form language models from the extracted text elements/sub-elements and the like generated by the above method.

It will be appreciated that the method can repeated as often as desired to update the user dependent language model, and subsequent updates can include texts created by the user with a speech recognition engine. In subsequent executions of the method, these texts and can assigned a higher priority (for instance, B₀) when extracted, and can also be used as an objective measure of the effectiveness of the user dependent language model, for instance, to adjust the confidence factor assigned to the user dependent text element/sub-element set.

Additionally, it will be appreciated that all the method steps enumerated above are not necessary for every execution of a method of making a user dependent language model according to the present invention. Also, the steps are not necessarily limited to the sequence described, and many steps can be performed in other orders, in parallel and/or in iterations.

From the foregoing, it will be appreciated that various features of the present invention allow for the quick and easy creation of a language model that can be highly user-specific and largely application independent. Notably, the language model can be created without the need for any specific efforts on the part of the user. This is particularly advantageous in connection with personal computers, where a user can initially install a speech recognition engine that can then automatically generate a language model dependent on this user, pursuant to the present invention, before the user has ever used the speech recognition engine. Thus, the “out-of-the-box” accuracy for the speech recognition engine can be significantly enhanced without the added effort and expense of initial training. Accordingly, users are encouraged to begin using the speech recognition immediately, rather than being discouraged by the amount of initial training required.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

What is claimed is:

1. A method of making a language model for a speech recognition engine, the method comprising:
reviewing a plurality of user-viewed data files;
extracting texts from the data files;
associating weighting factors with the extracted texts; and
generating a sorted text element list based on the extracted texts and the weighting factors.

2. The method of claim 1, wherein generating the sorted text element list includes:
generating a merged text element list based on the extracted texts;
determining total weighted occurrences for the text elements in the merged text element list; and
sorting the merged text element list based on the total weighted occurrences of the text elements.

3. The method of claim 2, wherein generating the merged text element list based on the extracted texts includes:
generating separate text elements lists from the extracted texts; and
merging the separate text element lists.

4. The method claim 3, wherein generating the separate text element lists includes:
determining occurrences for the text elements in the separate text element lists; and
applying the weighting factors to the occurrences to determine weighted occurrences for the text elements in the separate text element lists.

5. The method of claim 4, wherein determining the total weighted occurrences for the text elements in the merged text element list includes summing the weighted occurrences for the text elements in the separate text element lists.

6. The method of claim 1, wherein associating weighting factors with the extracted texts includes estimating how closely the extracted texts represent user language usage.

7. The method of claim 1, wherein associating weighting factors with the extracted texts includes weighting user-generated extracted texts higher than other extracted texts.

8. The method claim 7, wherein associating weighting factors with the extracted texts includes weighting the user-generated extracted texts from correspondence data files higher than other user-generated extracted texts.

9. The method of claim 7, wherein associating weighting factors with the extracted texts includes weighting the other extracted texts from correspondence data files higher than the other extracted texts not from correspondence data files.

10. The method of claim 9, wherein associating weighting factors with the extracted texts includes weighting the other extracted texts from correspondence data files with user replies higher than the other extracted texts from correspondence data files without user replies.

11. The method of claim 1, wherein reviewing the plurality of user-viewed data files includes reviewing user-viewed data files stored on a user personal computer.

12. The method of claim 1, further comprising:
generating a sorted text sub-element list based on the extracted texts and the weighting factors.

13. The method of claim 12, further comprising generating a temporary text sub-element list from the sorted text element list and selectively eliminating text sub-elements based on a comparison of the temporary text sub-element list and the sorted text sub-element list.

14. The method of claim 13, wherein text sub-elements occurring in both the temporary text sub-element list and the sorted text sub-element list are eliminated unless comparative occurrences are within a predetermined occurrence threshold.

15. The method of claim 1, further comprising associating topic identifications with the extracted texts.

16. The method of claim 1, wherein the language model is made prior to initial use of the speech recognition engine.

17. A method of making a language model for a speech recognition engine, the method comprising:
reviewing a plurality of user-viewed data files, at least one of the data files including non-transcribed text;
extracting texts from the data files; and
generating a merged text element list based on the extracted texts.

18. The method of claim 17, further comprising:
associating weighting factors with the extracted texts; and
sorting the merged text element list based on the weighting factors.

19. The method of claim 18, wherein sorting the merged text element list based on the weighting factors includes:
determining total weighted occurrences for the text elements in the merged text element list; and
sorting the merged text element list based on the total weighted occurrences of the text elements.

20. The method of claim 18, wherein associating weighting factors with the extracted texts includes estimating how closely the extracted texts represent user language usage.

21. The method of claim 18, wherein associating weighting factors with the extracted texts includes weighting user-generated extracted texts higher than other extracted texts.

22. A system for making a language model for a speech recognition engine, the system comprising:
an extraction module configured to review a plurality of user-viewed data files and extract texts therefrom;
a segmentation module configured to generate separate text element lists from the extracted texts;
a merger module configured to generate a merged text element list from the separate text element lists; and
a sorting module configured to generate a sorted text element list based on the merged text element list.

23. The system of claim 22, wherein the extraction module is further configured to associate weighting factors with the extracted texts and the sorting module is further configured to generate the sorted text elements list from the merged text element list based on the weighting factors.

24. The system of claim 22, wherein the extraction module is further configured to associate weighting factors with the extracted texts by estimating how closely the extracted texts represent user language usage.

25. The system of claim 22, wherein the merger module is further configured to determine total weighted occurrences for text elements in the merged text element list.

26. The system of claim 25, wherein the sorting module is further configured to generate the sorted text elements list from the merged text element list based on the weighting factors by sorting the text elements in the merged text element list by the total weighted occurrences.
